(19) United States
(12) Patent Application Publication
(10) Pub. No.: US 2015/0365231 A1
(43) Pub. Date: Dec. 17, 2015

(54) METHOD FOR CONFIGURING A SECURE ELEMENT, KEY DERIVATION PROGRAM, COMPUTER PROGRAM PRODUCT AND CONFIGURABLE SECURE ELEMENT

(71) Applicant: NXP B.V., Eindhoven (NL)

(72) Inventors: Dimitri Warnez, Hamburg (DE); Thierry Gouraud, Evere (BE)

(21) Appl. No.: 14/730,178

(22) Filed: Jun. 3, 2015

(30) Foreign Application Priority Data
Jun. 12, 2014 (EP) 14172145.6

(51) Int. Cl. H04L 9/08

(52) U.S. Cl. CPC H04L 9/0866; H04L 9/0877

(57) ABSTRACT

There is disclosed a method for configuring a secure element, the method comprising: storing an application in the secure element; storing a master key in the secure element; storing a key derivation program in the secure element; generating, by the key derivation program, at least one application key for use by the application, wherein said generating comprises deriving the application key from the master key and an identifier of the secure element. Furthermore, a corresponding key derivation program, computer program product and configurable secure element are disclosed.

### FIELD

The present disclosure relates to a method for configuring a secure element. Furthermore, the present disclosure relates to a corresponding key derivation program, a corresponding computer program product and a corresponding configurable secure element.

### BACKGROUND

Smart cards and mobile devices, such as smart phones, may be used for carrying out many kinds of transactions. For example, smart cards and mobile devices may substitute traditional public transportation tickets or loyalty cards. In order to fulfill these functions, a smart card or mobile device typically contains a so-called secure element. A secure element may for example be an embedded chip, more specifically a tamper-resistant integrated circuit with installed or pre-installed smart-card-grade applications, for instance payment applications, which have a prescribed functionality and a prescribed level of security. Furthermore, a secure element may implement security functions, such as cryptographic functions and authentication functions.

In order to be used in transactions, a secure element needs to be configured. More specifically, application keys need to be injected into the secure element. For example, if a secure element is embedded in an access control card, then an application key may be used for the purpose of authenticating a particular user, such that the user may access a building. If the secure element is embedded in a payment card, then an application key may be used to generate a cryptographic signature for use in a transaction, for example. Typically, the injection of application keys has to be done using secure equipment, secure environments and/or complex back-ends. For example, if the secure element is embedded in a mobile device, then a so-called Trusted Service Manager (TSM) may perform this injection. The injection of application keys may be a costly and relatively complex operation.

For example, EP 1 622 098 A1 describes a method for completing the manufacturing phases of an IC card performing a final and secure personalization phase of a semi-finished IC card including a non volatile memory portion wherein personalization data and information are stored in secret allocations, wherein certain steps are performed such that personalization data are stored in the card without any knowledge about the location wherein the data will be stored. More specifically, according to the described method the knowledge of the data location is hidden for the entity performing the final personalization phase. This known method illustrates that relatively complex measures are taken to ensure that the personalization process is secure.

### SUMMARY

There is disclosed a method for configuring a secure element, the method comprising: storing an application in the secure element; storing a master key in the secure element; storing a key derivation program in the secure element; generating, by the key derivation program, at least one application key for use by the application, wherein said generating comprises deriving the application key from the master key and an identifier of the secure element.

In one or more illustrative embodiments, a microcontroller unit of the secure element stores the application, the master key and the key derivation program, and the microcontroller unit executes the key derivation program in order to generate the application key.

In one or more further illustrative embodiments, the key derivation program and the master key are comprised in a single software package.

In one or more further illustrative embodiments, the identifier of the secure element is a unique identifier (UID) of the secure element.

In one or more further illustrative embodiments, the application is a virtual smart card application.

In one or more further illustrative embodiments, the virtual smart card application is a MIFARE application.

Furthermore, there is disclosed a key derivation program for use in a method of the kind set forth.

Furthermore, there is disclosed a computer program product comprising instructions which, when being executed by a processing unit, carry out or control a method of the kind set forth.

Furthermore, there is disclosed a configurable secure element which comprises an application, a master key and a key derivation program, and which is arranged to execute the key derivation program, such that the key derivation program, when being executed, generates at least one application key for use by the application by deriving the application key from the master key and an identifier of the secure element.

In one or more further illustrative embodiments, the secure element comprises a microcontroller unit, wherein the microcontroller unit is arranged to store the application, the master key and the key derivation program, and wherein the microcontroller unit is further arranged to execute the key derivation program.

Furthermore, a smart card is conceived which comprises a secure element of the kind set forth.

Furthermore, a mobile device is conceived which comprises a secure element of the kind set forth.

### DESCRIPTION OF DRAWINGS

Embodiments will be described in more detail with reference to the appended drawings, in which:

FIG. 1 shows an example of a mobile device comprising a secure element;

FIG. 2 shows an illustrative embodiment of a method for configuring a secure element.

### DESCRIPTION OF EMBODIMENTS

In accordance with the present disclosure, the key generation for, for example, a smart card application may be performed on-card. Since the personalization is performed on the card, i.e. not off-card by means of specialized secure equipment, the personalization of smart cards may become easier and cheaper. It is noted that the disclosed method may be applied both to secure elements embedded in smart cards and to secure elements embedded in mobile devices, such as NFC-enabled mobile phones. More specifically, the disclosed method may be used to advantage in mobile devices capable of executing virtual smart card applications, for example MIFARE® applications.

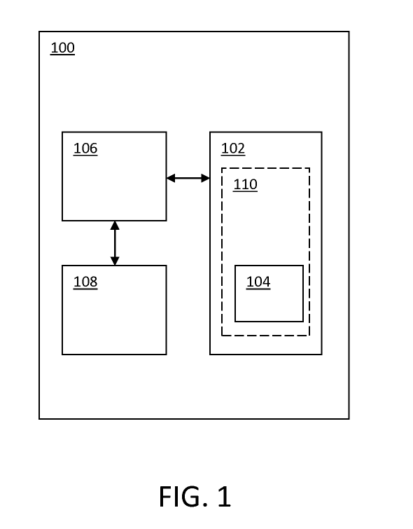

FIG. 1 shows an example of a mobile device 100 comprising a secure element 102. In addition to the secure element 102, the mobile device 100 may comprise an NFC controller 106 and an NFC antenna 108, in order to establish near-field communication between the mobile device 100 and an NFC reader device (not shown). For example, the NFC reader device may be embedded in or connected to a Point-of-Sale (POS) terminal, in order to carry out monetary transactions. In another example, the NFC reader device may be embedded in or connected to a check-in/check-out terminal in a public transportation system. The secure element 102 may comprise a memory unit 104 in which an application may have been stored. The application may be a payment application, for example. The application may require one or more application keys, in particular cryptographic keys, in order to perform cryptographic operations for protecting payment data. In accordance with the present disclosure, these application keys are generated in the secure element, in particular by a key derivation program that may have been stored, for example, in the same memory unit 104 in which the application resides.

Optionally, in one or more illustrative embodiments, the secure element may comprise a microcontroller unit 110. In that case, the memory unit 104 may be embedded in the microcontroller unit 110. The microcontroller unit may store the application, the master key and the key derivation program in its embedded memory 104. Furthermore, the microcontroller unit may execute the key derivation program. Thereby, the derivation of the application key is confined to a relatively secure environment.

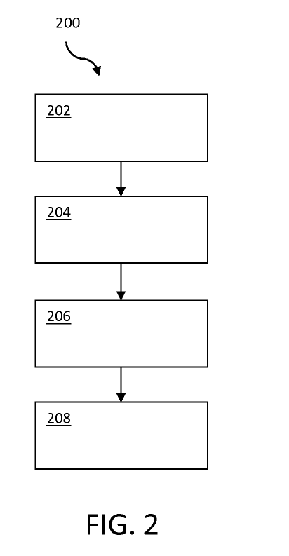

FIG. 2 shows an illustrative embodiment of a method 200 for configuring a secure element. The secure element is configured by storing, at 202, an application in the secure element, at 204 storing a master key in the secure element, and at 206 storing a key derivation program in the secure element. Furthermore, at 208, the key derivation program generates at least one application key for use by the application, in particular by deriving the application key from the master key and an identifier of the secure element.

Thus, a large amount of secure elements may share the same key derivation program and the same master key, which makes the management of said secure elements relatively easy and cheap. The key derivation program may use IC-specific data, i.e. data which are specific to the secure element, as a basis for deriving personalized keys, i.e. application keys. For example, the key derivation program may derive one or more application keys from the master key and the unique identifier (UID) of the secure element. This identifier is by definition unique and therefore facilitates the generation of a unique application key. It is noted that algorithms for deriving a key from a master key and a further value, such as an identifier, are known as such.

In one or more illustrative embodiments, the key derivation program and the master key may be comprised in a single software package. This facilitates the transfer of the master key to the secure element. The key derivation program may be loaded into the secure element by the manufacturer or issuer of the secure element, for example. The key derivation program may be loaded using a secure loading process.

In an illustrative use case, a contactless loyalty card may store a certain value in the form of points in its secure element. This value may need to be changed, for example if said points are exchanged for goods or services by a corresponding loyalty application (app). For example, a back-end system may request the loyalty app to decrease said value if goods or services are ordered by the card owner. In order to change said value, authentication towards the secure element of said card may be required using a specific user key, i.e. a loyalty application key. Loyalty application keys typically differ per secure element. In accordance with the present disclosure, a key derivation program and a master key have been stored in the secure element, for example by the manufacturer or issuer of the secure element, or by the manufacturer or issuer of the loyalty card. The key derivation program derives the loyalty application key from the master key and the UID of the secure element. Then, the key derivation program may provide the loyalty application key to the loyalty app. A back-end system may derive the same loyalty application key using the same key derivation program, master key and UID, in order to authenticate itself to the loyalty app, thereby enabling said authentication towards the secure element.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject- matters, in particular a combination of features of the method-type claims and features of the apparatus-type claims, is considered to be disclosed with this document.

Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 mobile device
102 secure element
104 memory unit
106 NFC controller
108 NFC antenna
110 microcontroller unit
200 configuration method
202 store application
204 store master key
206 store key derivation program
208 generate application key

1. A method for configuring a secure element, the method comprising:
storing an application in the secure element;
storing a master key in the secure element;
storing a key derivation program in the secure element;
generating, by the key derivation program, at least one application key for use by the application, wherein said generating comprises deriving the application key from the master key and an identifier of the secure element.

2. A method as claimed in claim 1, wherein a microcontroller unit of the secure element stores the application, the master key and the key derivation program, and wherein the microcontroller unit executes the key derivation program in order to generate the application key.

3. A method as claimed in claim 1, wherein the key derivation program and the master key are comprised in a single software package.

4. A method as claimed in claim 1, wherein the identifier of the secure element is a unique identifier, UID, of the secure element.

5. A method as claimed in claim 1, wherein the application is a virtual smart card application.

6. A method as claimed in claim 5, wherein the virtual smart card application is a MIFARE application.

7. A key derivation program for use in a method as claimed in claim 1.

8. A computer program product comprising instructions which, when being executed by a processing unit, carry out or control a method as claimed in claim 1.

9. A configurable secure element comprising:
an application;
a master key;
a key derivation program;
the secure element being arranged to execute the key derivation program, such that the key derivation program, when being executed, generates at least one application key for use by the application by deriving the application key from the master key and an identifier of the secure element.

10. A secure element as claimed in claim 9, comprising a microcontroller unit, wherein the microcontroller unit is arranged to store the application, the master key and the key derivation program, and wherein the microcontroller unit is further arranged to execute the key derivation program.

11. A smart card comprising a secure element as claimed in claim 9.

12. A mobile device comprising a secure element as claimed in claim 9.
